(19) United States
(12) Patent Application Publication
(10) Pub. No.: US 2026/0063248 A1
(43) Pub. Date: Mar. 5, 2026

(54) HYDROGEN FILLING APPARATUS

(71) Applicant: TOYOTA JIDOSHA KABUSHIKI KAISHA, Toyota-shi (JP)

(72) Inventor: Chiaki KATAOKA, Nagakute-shi (JP)

(73) Assignee: TOYOTA JIDOSHA KABUSHIKI KAISHA, Toyota-shi (JP)

(21) Appl. No.: 19/098,242

(22) Filed: Apr. 2, 2025

(30) Foreign Application Priority Data
Aug. 27, 2024 (JP) 2024-145823

(51) Int. Cl. F17C 5/06; F17C 5/00

(52) U.S. Cl. CPC F17C 5/06; F17C 5/007; F17C 2205/0326; F17C 2205/0388; F17C 2221/012; F17C 2223/0123; F17C 2227/043

(57) ABSTRACT

A hydrogen filling apparatus includes a plurality of first connection ports connectable to a plurality of respective first hydrogen tanks, a common flow channel, a first branch flow channel that joins a first end of the common flow channel and the respective first connection ports, a plurality of second connection ports connectable to a plurality of respective second hydrogen tanks, a second branch flow channel that joins the second end of the common flow channel and the respective second connection ports, a plurality of first valves provided in the first branch flow channel to correspond to the respective first connection ports, a plurality of second valves provided in the second branch flow channel to correspond to the respective second connection ports, and a control unit that enables the respective first valves and the respective second valves to be individually opened and closed.

### CROSS-REFERENCE TO RELATED APPLICATION

This application claims priority to Japanese Patent Application No. 2024-145823 filed on Aug. 27, 2024. The disclosure of the above-identified application, including the specification, drawings, and claims, is incorporated by reference herein in its entirety.

### BACKGROUND

### 1. Technical Field

The technology disclosed in the present specification relates to a hydrogen filling apparatus.

### 2. Description of Related Art

Japanese Unexamined Patent Application Publication No. 2019-143672 (JP 2019-143672 A) discloses a hydrogen filling apparatus capable of filling a plurality of hydrogen tanks at the same time. The hydrogen filling apparatus includes a common pipe having a first end connected to a hydrogen gas source (hydrogen pressure accumulator tank) and having a plurality of openings up to a second end, and attachment and detachment ports provided at the respective openings of the common pipe. A plurality of attachable and detachable hydrogen tanks is connected to the respective attachment and detachment ports.

### SUMMARY

The use of hydrogen is expected to expand. It is conceivable to prepare even a plurality of hydrogen supply sources for hydrogen filling in addition to a plurality of hydrogen tanks serving as hydrogen filling targets as in JP 2019-143672 A. In relation to such hydrogen filling, a configuration is requested that makes it possible to flexibly meet various needs for increasing the efficiency of filling and selecting a hydrogen supply source or a hydrogen filling target.

The present specification discloses a hydrogen filling apparatus that fills a hydrogen filling target with hydrogen from a hydrogen supply source by using differential pressure. The hydrogen filling apparatus includes: a plurality of first connection ports; a common flow channel; a first branch flow channel; a plurality of second connection ports; a second branch flow channel; a plurality of first valves; a plurality of second valves; and a control unit. The plurality of first connection ports is connectable to a plurality of respective first hydrogen tanks serving as the hydrogen supply sources. The first branch flow channel is a flow channel branching to the respective first connection ports. The first branch flow channel joins a first end of the common flow channel and the respective first connection ports. The plurality of second connection ports is connectable to a plurality of respective second hydrogen tanks serving as the hydrogen filling targets. The second branch flow channel is a flow channel branching to the respective second connection ports. The second branch flow channel joins a second end of the common flow channel and the respective second connection ports. The plurality of first valves is provided in the first branch flow channel to correspond to the respective first connection ports. The plurality of second valves is provided in the second branch flow channel to correspond to the respective second connection ports. The control unit enables the respective first valves and the respective second valves to be individually opened and closed. The control unit then fills one or more of the second hydrogen tanks with hydrogen from one or more of the first hydrogen tanks through the first branch flow channel, the common flow channel, and the second branch flow channel by opening one or more of the first valves corresponding to the first connection ports to which the first hydrogen tanks are connected and opening one or more of the second valves corresponding to the second connection ports to which the second hydrogen tanks are connected.

According to the configuration, the control unit allows the respective provided first valves and the respective provided second valves to be individually opened and closed. It is thus possible to select a first hydrogen tank and a second hydrogen tank or control the selection timings. It is thus possible to flexibly meet various needs for increasing the efficiency of hydrogen filling and selecting a hydrogen supply source or a hydrogen filling target.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram simply illustrating a configuration of a hydrogen filling system according to a first embodiment;

FIG. 2 is a diagram simply illustrating a relationship between an amount of remaining hydrogen of a first hydrogen tank group and an amount of remaining hydrogen of a second hydrogen tank group in each of steps S0 to S4 in the first embodiment;

FIG. 3 is a diagram simply illustrating a relationship between the amount of remaining hydrogen of the first hydrogen tank group and the amount of remaining hydrogen of the second hydrogen tank group in each of steps S5 to S9 in the first embodiment;

FIG. 4 is a diagram simply illustrating a relationship between an amount of remaining hydrogen of a first hydrogen tank group and an amount of remaining hydrogen of a second hydrogen tank group in a comparative example;

FIG. 5 is a diagram simply illustrating a result obtained by filling a second hydrogen tank group with hydrogen in a second embodiment; and

FIG. 6 is a diagram simply illustrating a configuration of a hydrogen filling system according to a third embodiment.

### DETAILED DESCRIPTION OF EMBODIMENTS

The present embodiment will be described with reference to the drawings. The respective drawings are merely examples and the present embodiment is not limited to the illustrated examples. In addition, the respective drawings are examples and some parts may be omitted.

### First Embodiment

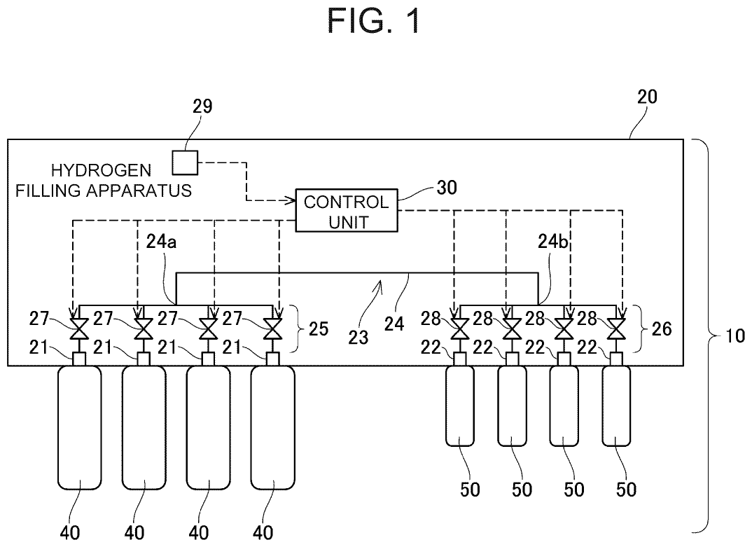

FIG. 1 simply illustrates the configuration of a hydrogen filling system 10 according to a first embodiment. The hydrogen filling system 10 includes a hydrogen filling apparatus 20. The hydrogen filling apparatus 20 fills a hydrogen filling target with hydrogen from a hydrogen supply source by using differential pressure. The hydrogen filling apparatus 20 includes a plurality of first connection ports 21 connectable to a plurality of respective first hydrogen tanks 40 serving as a plurality of hydrogen supply sources. The first hydrogen tanks 40 are each attachable and detachable to and from the first connection port 21. The one first hydrogen tank 40 is mounted on (connected to) the one first connection port 21. The first hydrogen tank 40 is filled with hydrogen gas in advance. The hydrogen filling apparatus 20 includes a plurality of second connection ports 22 connectable to a plurality of respective second hydrogen tanks 50 serving as a plurality of hydrogen filling targets. The second hydrogen tanks 50 are each attachable and detachable to and from the second connection ports 22. The one second hydrogen tank 50 is mounted on (connected to) the one second connection port 22.

FIG. 1 illustrates the four first connection ports 21 and the four second connection ports 22. Needless to say, the number of first connection ports 21 and the number of second connection ports 22 are not, however, limited. The number of first connection ports 21 and the number of second connection ports 22 may be the same or different. A comparison between the first hydrogen tanks 40 and the second hydrogen tanks 50 shows, for example, that the second hydrogen tanks 50 are tanks which are relatively easier in size for a user to carry. The first hydrogen tanks 40 may be each considered a higher-volume hydrogen tank than the second hydrogen tank 50.

The hydrogen filling apparatus 20 includes a flow channel 23 that connects the first connection ports 21 and the second connection ports 22. The flow channel may be referred to as a pipe. The flow channel 23 includes a common flow channel 24, a first branch flow channel 25, and a second branch flow channel 26. The first branch flow channel 25 is a flow channel branching to the respective first connection ports 21. The first branch flow channel 25 joins a first end 24a of the common flow channel 24 and the respective first connection ports 21. When the first connection port 21 side is considered an upstream side and the first end 24a side of the common flow channel 24 is considered a downstream side, it is possible to consider that a plurality of flow channels joined to the first connection ports 21 one to one extends downstream and merges together to be joined to the first end 24a in the first branch flow channel 25.

The second branch flow channel 26 is a flow channel branching to the respective second connection ports 22. The second branch flow channel 26 joins a second end 24b of the common flow channel 24 and the respective second connection ports 22. When the second end 24b side of the common flow channel 24 is considered an upstream side and the second connection port 22 side is considered a downstream side, it is possible to consider that a plurality of flow channels extends downstream from the second end 24b and the respective flow channels are joined to the second connection ports 22 one to one in the second branch flow channel 26.

The hydrogen filling apparatus 20 includes a plurality of first valves 27 provided in the first branch flow channel 25 to correspond to the respective first connection ports 21, and a plurality of second valves 28 provided in the second branch flow channel 26 to correspond to the respective second connection ports 22. That is, in the first branch flow channel 25, the respective flow channels joined to the first connection ports 21 are provided with the first valves 27 in a one-to-one relationship with the first connection ports 21. In addition, in the second branch flow channel 26, the respective flow channels joined to the second connection ports 22 are provided with the second valves 28 in a one-to-one relationship with the second connection ports 22. The respective valves included in the hydrogen filling apparatus 20 are, for example, electromagnetic valves, and each open and close the corresponding flow channel.

The hydrogen filling apparatus 20 includes a control unit 30. The control unit 30 is one of controllers that control the hydrogen filling apparatus 20. The control unit 30 includes, for example, at least one of electronic control units (ECUs) mounted on the hydrogen filling apparatus 20. The control unit 30 allows the first valves 27 and the second valves 28 to be individually opened and closed. The control unit 30 then opens one or more of the first valves 27 corresponding to the first connection ports 21 to which the first hydrogen tanks 40 are connected, and opens one or more of the second valves 28 corresponding to the second connection ports 22 to which the second hydrogen tanks 50 are connected.

The control unit 30 is capable of sensing whether or not any of the first hydrogen tanks 40 is connected to the first connection port 21 or whether or not any of the second hydrogen tanks 50 is connected to the second connection port 22, for example, for each of the connection ports through an unillustrated sensor. The control unit 30 thus selects and opens one or more of the first valves 27 corresponding to the first connection ports 21 to which the first hydrogen tanks 40 are connected, and selects and opens one or more of the second valves 28 corresponding to the second connection ports 22 to which the second hydrogen tanks 50 are connected. It is thus possible for the control unit 30 to fill the one or more second hydrogen tanks 50 with hydrogen from the one or more first hydrogen tanks 40 through the first branch flow channel 25, the common flow channel 24, and the second branch flow channel 26.

The control unit 30 may be triggered by an external instruction to execute processing of selecting and opening the first valves 27 and the second valves 28. According to FIG. 1, for example, the hydrogen filling apparatus 20 is provided with a filling start button 29. A user who wishes to fill the second hydrogen tanks 50 with hydrogen from the first hydrogen tanks 40 presses the filling start button 29. Triggered by the pressed filling start button 29, the control unit 30 may open the first valves 27 and the second valves 28 as described above to start hydrogen filling.

Opening/closing one valve corresponding to a connection port to which one certain hydrogen tank is connected will be sometimes expressed simply as opening/closing a hydrogen tank below.

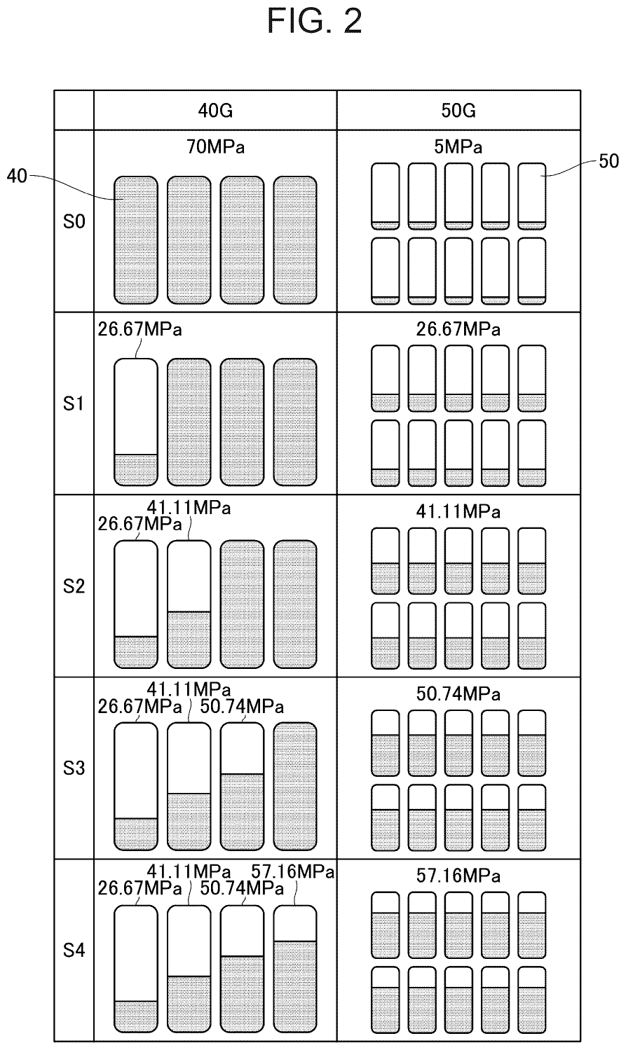

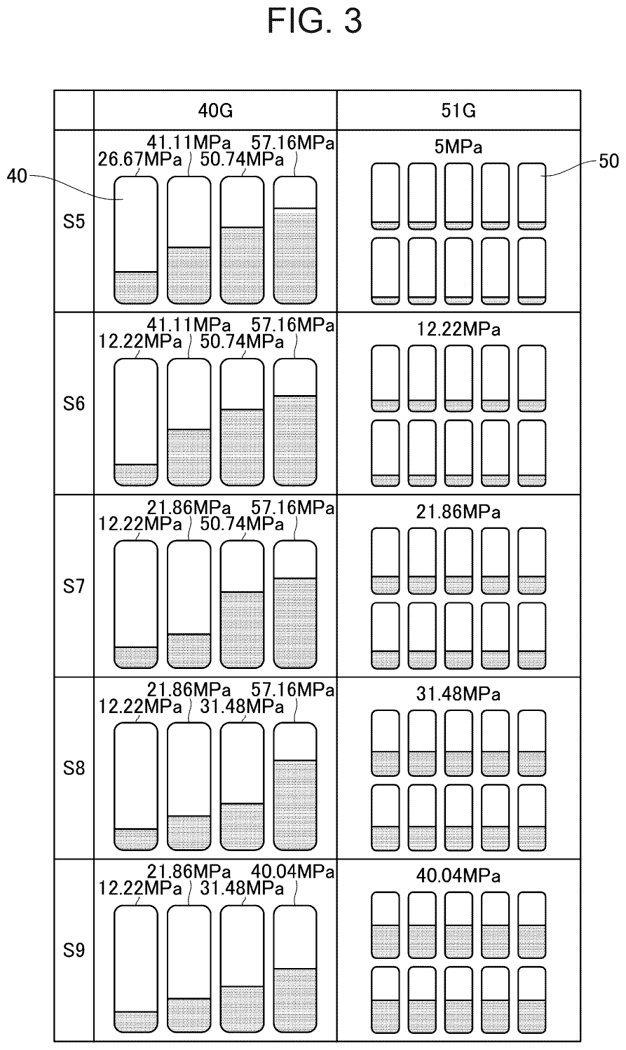

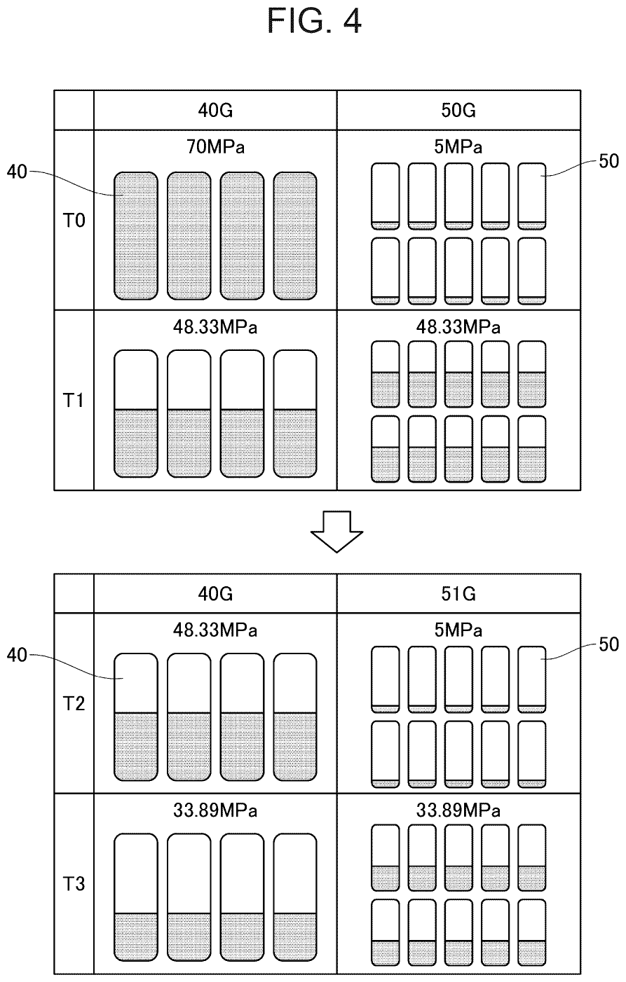

Next, an example of hydrogen filling processing executed by the hydrogen filling apparatus 20 will be described with reference to FIG. 2 to FIG. 4. FIG. 2 and FIG. 3 simply illustrate the relationships of the amount of remaining hydrogen of a first hydrogen tank group 40G and the amounts of remaining hydrogen of second hydrogen tank groups 50G, 51G in each of a plurality of situations (steps S0 to S9) in the present embodiment. FIG. 4 is a comparative example of FIG. 2 and FIG. 3 and simply illustrates the relationships of the amount of remaining hydrogen of the first hydrogen tank group 40G and the amounts of remaining hydrogen of the second hydrogen tank groups 50G, 51G in each of a plurality of situations (steps T0 to T3).

The first hydrogen tanks 40 connected to the first connection ports 21 of the hydrogen filling apparatus 20 are collectively referred to as the first hydrogen tank group 40G. According to FIG. 2 to FIG. 4, the first hydrogen tank group 40G includes the four first hydrogen tanks 40. Similarly, the second hydrogen tanks 50 connected to the second connection ports 22 of the hydrogen filling apparatus 20 are collectively referred to as the second hydrogen tank groups 50G, 51G. According to FIG. 2 to FIG. 4, each of the second hydrogen tank groups 50G, 51G includes the ten second hydrogen tanks 50.

In each of the present embodiment and a comparative example, the second hydrogen tank group 50G is connected to the hydrogen filling apparatus 20 before the second hydrogen tank group 51G. The second hydrogen tank group 50G is filled with hydrogen from the first hydrogen tank group 40G (steps S0 to S4 and steps T0 to T1). The second hydrogen tank group 50G filled with hydrogen is then detached from the hydrogen filling apparatus 20. Thereafter, the second hydrogen tank group 51G is connected to the hydrogen filling apparatus 20. The second hydrogen tank group 51G is then filled with hydrogen from the first hydrogen tank group 40G from which the second hydrogen tank group 50G has been filled with hydrogen (steps S5 to S9 and steps T2 to T3).

The one first hydrogen tank 40 has, for example, an internal volume of 25 L. The first hydrogen tank group 40G has an internal volume of 25 L×4=100 L. In addition, the one second hydrogen tank 50 has, for example, an internal volume of 5 L. Each of the second hydrogen tank groups 50G, 51G has an internal volume of 5 L×10=50 L. Each of the first hydrogen tanks 40 has, for example, an in-tank pressure of 70 MPa in a situation (steps S0, T0) in which the second hydrogen tank group 50G has not started to be filled with hydrogen. The first hydrogen tanks 40 each having an in-tank pressure of 70 MPa may be considered almost full. In addition, in steps S0, T0, each of the second hydrogen tanks 50 included in the second hydrogen tank group 50G has, for example, an in-tank pressure of 5 MPa. In a situation (step S5, T2) in which the second hydrogen tank group 51G has not started to be filled with hydrogen, each of the second hydrogen tanks 50 included in the second hydrogen tank group 51G has, for example, an in-tank pressure of 5 MPa. Here, the second hydrogen tanks 50 each having an in-tank pressure of 5 MPa may be considered almost empty.

It is considered possible for the control unit 30 to obtain the in-tank pressure of each of the first hydrogen tanks 40 connected to the respective first connection ports 21 through an unillustrated pressure sensor. The pressure sensor may be provided in the first branch flow channel 25 for each of the first connection ports 21 or may be provided in the common flow channel 24. It is possible for the control unit 30 to obtain the in-tank pressures of the respective first hydrogen tanks 40 by individually opening the first hydrogen tanks 40. Furthermore, it may be possible for the control unit 30 to obtain the in-tank pressure of each of the second hydrogen tanks 50 connected to the respective second connection ports 22 through an unillustrated pressure sensor. Each of FIG. 2 to FIG. 5 simply exemplifies the amount of hydrogen remaining in each of the first hydrogen tanks 40 and the second hydrogen tanks 50 by using the gray-colored area ratio of the tank. Needless to say, hydrogen is not actually distributed unevenly in a partial area of a tank as illustrated in each of FIG. 2 to FIG. 5.

P1 [MPa] represents the in-tank pressure of a hydrogen supply source obtained before a hydrogen filling target starts to be filled with hydrogen from the hydrogen supply source, and P2 [MPa] represents the in-tank pressure of the hydrogen filling target obtained before the hydrogen filling target starts to be filled with hydrogen from the hydrogen supply source. In addition, V1 [L] represents the internal volume of the hydrogen supply source and V2 [L] represents the internal volume of the hydrogen filling target. It is possible to express, by the following Equation (1), in-tank pressure P [MPa] obtained after hydrogen filling in a differential pressure filling method. It is, however, assumed that the temperature of hydrogen gas remains the same before and after filling.

$$P = ( P 1 \times V 1 + P 2 \times V 2 ) / ( V 1 + V 2 ) \qquad ( 1 )$$

In the comparative example, the control unit 30 opens all the first hydrogen tanks 40 included in the first hydrogen tank group 40G and all the second hydrogen tanks 50 included in the second hydrogen tank group 50G in step TO. As a result, according to Equation (1), the in-tank pressure P is as follows.

$$P = ( 70 \times 100 + 5 \times 50 ) / ( 100 + 50 ) = 48.33 MPa$$

That is, as a result obtained by filling the second hydrogen tank group 50G with hydrogen from the first hydrogen tank group 40G, the respective first hydrogen tanks 40 and the respective second hydrogen tanks 50 each have an in-tank pressure of about 48.33 MPa in step T1. Although not described in detail, the control unit 30 basically closes a hydrogen tank that has been once opened unless it is necessary to open the hydrogen tank for hydrogen supply or hydrogen filling.

The second hydrogen tank group 50G is exchanged with the second hydrogen tank group 51G. The control unit 30 then opens all the first hydrogen tanks 40 included in the first hydrogen tank group 40G and all the second hydrogen tanks 50 included in the second hydrogen tank group 51G in step T2. As a result, according to Equation (1), the in-tank pressure P is as follows.

$$P = ( 48.33 \times 100 + 5 \times 50 ) / ( 100 + 50 ) = 33.89 MPa$$

That is, as a result obtained by filling the second hydrogen tank group 51G with hydrogen from the first hydrogen tank group 40G, the respective first hydrogen tanks 40 and the respective second hydrogen tanks 50 each have an in-tank pressure of about 33.89 MPa in step T3.

In contrast to the comparative example as described above, the control unit 30 opens the first valves 27 one by one in order in the present embodiment. The first valves 27 correspond to the first connection ports 21 to which the first hydrogen tanks 40 are connected. The control unit 30 opens any one of the first hydrogen tanks 40 included in the first hydrogen tank group 40G and all the second hydrogen tanks 50 included in the second hydrogen tank group 50G in step S0 in FIG. 2. In the description of each of FIG. 2 and FIG. 3, the four first hydrogen tanks 40 included in the first hydrogen tank group 40G are referred to, for example, as the first tank, the second tank, the third tank, and the fourth tank in the order from left to right for the sake of simplification. That is, in steps S0 to S4, the control unit 30 opens the first hydrogen tanks 40 in the order of the first tank, the second tank, the third tank, and the fourth tank. In steps S5 to S9, the control unit 30 similarly opens the first hydrogen tanks 40 in the order of the first tank, the second tank, the third tank, and the fourth tank.

In step S0, the control unit 30 opens the first hydrogen tank 40 that is the first tank. As a result, according to Equation (1), the in-tank pressure P is as follows.

$$P = ( 70 \times 25 + 5 \times 50 ) / ( 25 + 50 ) = 26.67 MPa$$

That is, as a result obtained by filling the second hydrogen tank group 50G with hydrogen from the first hydrogen tank 40 that is the first tank, the first hydrogen tank 40 that is the first tank and the respective second hydrogen tanks 50 each have an in-tank pressure of about 26.67 MPa in step S1.

Next, the control unit 30 opens the first hydrogen tank 40 that is the second tank and all the second hydrogen tanks 50 included in the second hydrogen tank group 50G. As a result, according to Equation (1), the in-tank pressure P is as follows.

$$P = ( 70 \times 25 + 26.67 \times 50 ) / ( 25 + 50 ) = 41.11 MPa$$

That is, as a result obtained by filling the second hydrogen tank group 50G with hydrogen from the first hydrogen tank 40 that is the second tank, the first hydrogen tank 40 that is the second tank and the respective second hydrogen tanks 50 each have an in-tank pressure of about 41.11 MPa in step S2.

Next, the control unit 30 opens the first hydrogen tank 40 that is the third tank and all the second hydrogen tanks 50 included in the second hydrogen tank group 50G. As a result, according to Equation (1), the in-tank pressure P is as follows.

$$P = ( 70 \times 25 + 41.11 \times 50 ) / ( 25 + 50 ) = 50.74 MPa$$

That is, as a result obtained by filling the second hydrogen tank group 50G with hydrogen from the first hydrogen tank 40 that is the third tank, the first hydrogen tank 40 that is the third tank and the respective second hydrogen tanks 50 each have an in-tank pressure of about 50.74 MPa in step S3.

Next, the control unit 30 opens the first hydrogen tank 40 that is the fourth tank and all the second hydrogen tanks 50 included in the second hydrogen tank group 50G. As a result, according to Equation (1), the in-tank pressure P is as follows.

$$P = ( 70 \times 25 + 50.74 \times 50 ) / ( 25 + 50 ) = 57.16 MPa$$

That is, as a result obtained by filling the second hydrogen tank group 50G with hydrogen from the first hydrogen tank 40 that is the fourth tank, the first hydrogen tank 40 that is the fourth tank and the respective second hydrogen tanks 50 each have an in-tank pressure of about 57.16 MPa in step S4.

If step S4 as described above is compared with step T1, it is possible in the present embodiment to fill each of the second hydrogen tanks 50 included in the second hydrogen tank group 50G with more hydrogen by 57.16 MPa-48.33 MPa=8.83 MPa, that is, up to higher pressure, than in the comparative example. As described above, the control unit 30 opens the first hydrogen tanks 40 one by one in order, thereby making it possible to increase the efficiency of filling the hydrogen filling target.

The second hydrogen tank group 50G is exchanged with the second hydrogen tank group 51G. The control unit 30 then opens the first hydrogen tank 40 that is the first tank the lowest in in-tank pressure and all the second hydrogen tanks 50 included in the second hydrogen tank group 51G in step S5. As a result, according to Equation (1), the in-tank pressure P is as follows.

$$P = ( 26.67 \times 25 + 5 \times 50 ) / ( 25 + 50 ) = 12.22 MPa$$

That is, as a result obtained by filling the second hydrogen tank group 51G with hydrogen from the first hydrogen tank 40 (in-tank pressure=26.67 MPa) that is the first tank, the first hydrogen tank 40 that is the first tank and the respective second hydrogen tanks 50 each have an in-tank pressure of about 12.22 MPa in step S6.

Hereinafter, the control unit 30 similarly opens the first hydrogen tanks 40 in the order of the second tank, the third tank, and the fourth tank (in ascending order of in-tank pressure) and accordingly opens all the second hydrogen tanks 50 for the second hydrogen tank group 51G. As a result obtained by filling the second hydrogen tank group 51G with hydrogen from the first hydrogen tank 40 (in-tank pressure=41.11 MPa) that is the second tank, the first hydrogen tank 40 that is the second tank and the respective second hydrogen tanks 50 each have an in-tank pressure of about 21.86 MPa in step S7. Next, as a result obtained by filling the second hydrogen tank group 51G with hydrogen from the first hydrogen tank 40 (in-tank pressure=50.74 MPa) that is the third tank, the first hydrogen tank 40 that is the third tank and the respective second hydrogen tanks 50 each have an in-tank pressure of about 31.48 MPa in step S8. Then, as a result obtained by filling the second hydrogen tank group 51G with hydrogen from the first hydrogen tank 40 (in-tank pressure=57.16 MPa) that is the fourth tank, the first hydrogen tank 40 that is the fourth tank and the respective second hydrogen tanks 50 each have an in-tank pressure of about 40.04 MPa in step S9.

If step S9 as described above is compared with step T3, it is possible in the present embodiment to fill each of the second hydrogen tanks 50 included in the second hydrogen tank group 51G with more hydrogen by 40.04 MPa-33.89 MPa=6.15 MPa, that is, up to higher pressure, than in the comparative example. As described above, the control unit 30 opens the first hydrogen tanks 40 one by one in order, thereby making it possible to increase the efficiency of filling the hydrogen filling target.

Furthermore, according to the description of steps S5 to S9, it is possible for the control unit 30 to obtain the in-tank pressure of each of the first hydrogen tanks 40 connected to the first connection ports 21. The control unit 30 opens the first valves 27 in the order from the first valves 27 corresponding to the first connection ports 21 to which the first hydrogen tanks 40 lower in in-tank pressure are connected. As described above, the first hydrogen tanks 40 are preferentially opened in the order from the first hydrogen tanks 40 lower in in-tank pressure to make it possible to effectively use the amount of remaining hydrogen of each of the first hydrogen tanks 40 and consequently fill a hydrogen filling target with hydrogen up to higher pressure.

### Second Embodiment

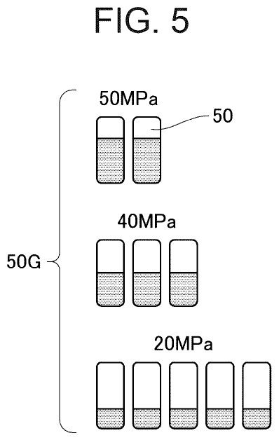

Next, a second embodiment will be described. In the second embodiment, what is common to the first embodiment will not be described. In the first embodiment, the respective second hydrogen tanks 50 included in the second hydrogen tank group 50G are filled with hydrogen similarly, that is, to be equal in in-tank pressure. The respective second hydrogen tanks 50 included in the second hydrogen tank group 51G are also filled with hydrogen to be equal in in-tank pressure. In contrast, the control unit 30 fills the second hydrogen tanks 50 with hydrogen in the second embodiment to make a difference in in-tank pressure between at least some of the second hydrogen tanks 50. FIG. 5 simply illustrates a result obtained by filling the second hydrogen tank group 50G with hydrogen in the second embodiment.

The control unit 30 first selects and opens, for example, the two second hydrogen tanks 50 of the ten second hydrogen tanks 50 included in the second hydrogen tank group 50G and fills the two second hydrogen tanks 50 with hydrogen. Each of the two second hydrogen tanks 50 is filled with hydrogen, for example, to achieve an in-tank pressure of about 50 MPa. Thereafter, the control unit 30 selects and opens, for example, the three second hydrogen tanks 50 of the seven remaining second hydrogen tanks 50 and fills the three second hydrogen tanks 50 with hydrogen. Each of the three second hydrogen tanks 50 is filled with hydrogen, for example, to achieve an in-tank pressure of about 40 MPa. Finally, the control unit 30 selects and opens the five remaining second hydrogen tanks 50 and fills the five remaining second hydrogen tanks 50 with hydrogen. Each of the five second hydrogen tanks 50 is filled with hydrogen, for example, to achieve an in-tank pressure of about 20 MPa.

As described above, the control unit 30 divides the second hydrogen tank group 50G into a plurality of groups. To fill the respective groups with hydrogen in different manners, the control unit 30 allows the first hydrogen tanks 40 serving as hydrogen supply sources to be opened in different manners for the respective groups. For example, it is possible to open a different number of first hydrogen tanks 40 for each of the groups, open the first hydrogen tanks 40 one by one for a certain group, or open the first hydrogen tanks 40 at the same time for a certain group. In addition, in a case where the first hydrogen tanks 40 are opened one by one in order, it is possible to select and open the first hydrogen tanks 40 in the order from the first hydrogen tanks 40 lower in in-tank pressure. Inversely, it is also possible to preferentially select and open the first hydrogen tanks 40 higher in in-tank pressure. The control unit 30 divides the second hydrogen tank group 50G into a plurality of groups as described above or recognize desired in-tank pressure for each of the groups, for example, in accordance with a request from a user to fill the second hydrogen tanks 50 with hydrogen such that the second hydrogen tanks 50 have a difference in in-tank pressure. According to the second embodiment as described above, it is possible for the control unit 30 to flexibly meet a detailed need for determining to what degree each of the second hydrogen tanks 50 is to be filled with hydrogen.

### Third Embodiment

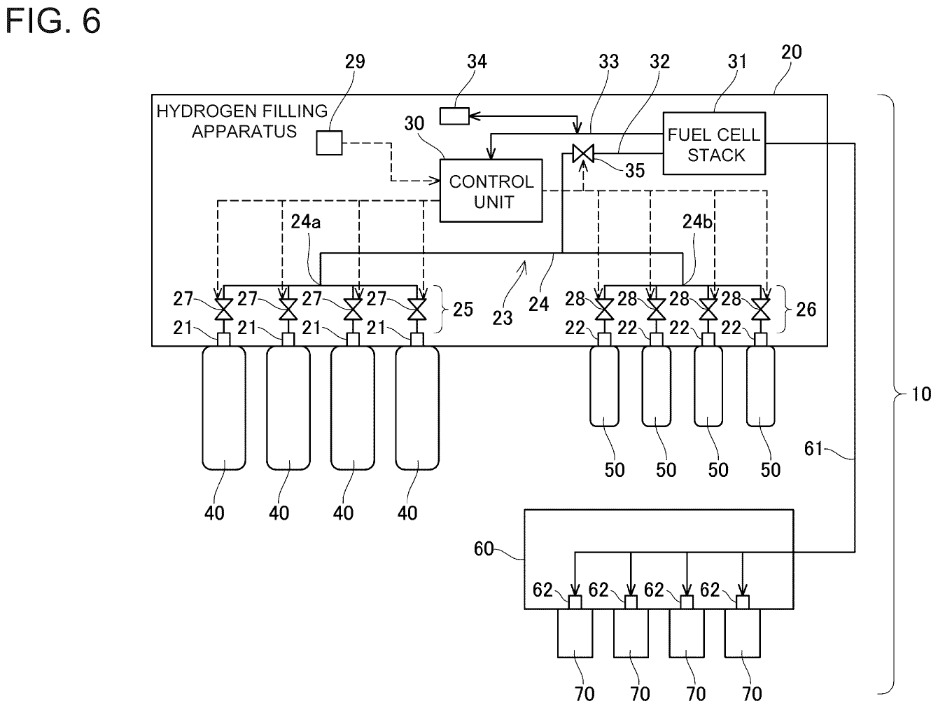

Next, a third embodiment will be described. It is possible to combine the third embodiment with the first embodiment or the second embodiment. FIG. 6 simply illustrates the configuration of the hydrogen filling system 10 according to the third embodiment. The hydrogen filling apparatus 20 may include a fuel cell stack 31 that generates electricity upon receiving hydrogen supplied from the first hydrogen tanks 40. The hydrogen filling apparatus 20 may be then actuated by the electricity generated by the fuel cell stack 31. As known, the fuel cell stack 31 includes a plurality of fuel cells that generates electricity by using hydrogen and oxygen as fuels.

According to FIG. 6, the flow channel 23 includes a third branch flow channel 32 that branches from the middle of the common flow channel 24 toward the fuel cell stack 31. Some of the hydrogen supplied from the one or more first hydrogen tanks 40 and flowing through the common flow channel 24 is thus supplied to the fuel cell stack 31 through the third branch flow channel 32. The fuel cell stack 31 uses the hydrogen thus supplied to generate electricity. The electricity generated by the fuel cell stack 31 is supplied to the control unit 30 through a predetermined electricity supply line 33 in the hydrogen filling apparatus 20 to actuate the control unit 30. Although not illustrated, the electricity generated by the fuel cell stack 31 is supplied to the respective components (e.g., the respective valves) in the hydrogen filling apparatus 20 that require electricity for actuation in addition to the control unit 30.

A chargeable and dischargeable battery 34 may be connected to the electricity supply line 33. That is, the fuel cell stack 31 is capable of charging the battery 34. In addition, the battery 34 serves as one of electricity supply sources for the control unit 30 and the control unit 30 is actuated by electricity supplied from the battery 34 in some cases.

The third branch flow channel 32 may be provided with a third valve 35 capable of opening and closing the flow channel. The control unit 30 also allows the third valve 35 to be individually opened and closed as with the first valves 27 and the second valves 28. The control unit 30 opens the third valve 35 to supply the fuel cell stack 31 with hydrogen from the first hydrogen tanks 40. In addition, it is possible for the control unit 30 to supply only the fuel cell stack 31 with hydrogen from the first hydrogen tanks 40 by opening the third valve 35 with all the second valves 28 closed. In addition, the control unit 30 closes the third valve 35 and opens the one or more second valves 28, thereby making it possible to fill the second hydrogen tanks 50 with hydrogen while forbidding the fuel cell stack 31 to be supplied with hydrogen from the first hydrogen tanks 40.

According to the third embodiment as described above, the hydrogen filling apparatus 20 includes the fuel cell stack 31. It is therefore possible for the hydrogen filling apparatus 20 to be actuated without being supplied with electricity from an external electricity source. That is, it is possible for the hydrogen filling apparatus 20 to come into autonomous operation by using electricity generated in the apparatus. It is therefore possible to actuate the hydrogen filling apparatus 20, for example, even at the time of an electric power outage. In addition, the degree of freedom for installation places is increased. Although not described in particular in the first embodiment or the second embodiment, the hydrogen filling apparatus 20 is actuated upon receiving electricity supplied from an external electricity source in a case where the apparatus has no electricity generation capacity.

Furthermore, as illustrated in FIG. 6, the hydrogen filling apparatus 20 may be capable of supplying an external battery charging station 60 with electricity from the fuel cell stack 31. The battery charging station 60 is supplied with electricity from the fuel cell stack 31 through the second electricity supply line 61. The battery charging station 60 includes one or more charging connectors 62. It is possible for a user to optionally connect batteries 70 to the charging connectors 62. The battery charging station 60 charges the batteries 70 through the charging connectors 62 with electricity supplied through the second electricity supply line 61. The battery charging station 60 may include an unillustrated controller such as an ECU that controls a start, a stop, or the like to charge the batteries 70.

According to the present embodiment including the respective embodiments as described above, the hydrogen filling apparatus 20 allows the respective provided first valves 27 and the respective provided second valves 28 to be individually opened and closed. It is therefore possible to select the first hydrogen tank 40 to be opened or the second hydrogen tank 50 to be opened, and control the selection timing. It is thus possible to flexibly meet various needs for increasing the efficiency of filling the second hydrogen tank 50 with hydrogen and selecting a hydrogen supply source or a hydrogen filling target. It is to be noted that a hydrogen supply source connected to the hydrogen filling apparatus 20 does not have to be the first hydrogen tank 40, but may be a larger hydrogen storage module or hydrogen storage system.

The specific examples of the technology disclosed in the present specification have been described in detail so far, but they are merely examples and do not limit the claims. The technology described in the claims includes a variety of modifications or alternations of the specific examples exemplified above. In addition, the technical usefulness is attained by the technical elements described in the present specification or the drawings alone or various combinations of the technical elements. The combinations described in the claims as filed are not limitative. In addition, the technology exemplified in the present specification or the drawings achieves a plurality of objects at the same time. Achieving one of the objects itself has technical usefulness.

What is claimed is:

1. A hydrogen filling apparatus that fills a hydrogen filling target with hydrogen from a hydrogen supply source by using differential pressure, the hydrogen filling apparatus comprising:
a plurality of first connection ports connectable to a plurality of respective first hydrogen tanks serving as the hydrogen supply sources;
a common flow channel;
a first branch flow channel that is a flow channel branching to the respective first connection ports, the first branch flow channel joining a first end of the common flow channel and the respective first connection ports;
a plurality of second connection ports connectable to a plurality of respective second hydrogen tanks serving as the hydrogen filling targets;
a second branch flow channel that is a flow channel branching to the respective second connection ports, the second branch flow channel joining a second end of the common flow channel and the respective second connection ports;
a plurality of first valves provided in the first branch flow channel to correspond to the respective first connection ports;
a plurality of second valves provided in the second branch flow channel to correspond to the respective second connection ports; and
a control unit that enables the respective first valves and the respective second valves to be individually opened and closed, wherein
the control unit fills one or more of the second hydrogen tanks with hydrogen from one or more of the first hydrogen tanks through the first branch flow channel, the common flow channel, and the second branch flow channel by opening one or more of the first valves corresponding to the first connection ports to which the first hydrogen tanks are connected and opening one or more of the second valves corresponding to the second connection ports to which the second hydrogen tanks are connected.

2. The hydrogen filling apparatus according to claim 1, wherein the control unit opens the first valves one by one in order, the first valves corresponding to the first connection ports to which the first hydrogen tanks are connected.

3. The hydrogen filling apparatus according to claim 2, wherein the control unit that is able to obtain in-tank pressure of each of the first hydrogen tanks connected to the first connection ports and opens the first valves in order from the first valves corresponding to the first connection ports to which the first hydrogen tanks lower in the in-tank pressure are connected.

4. The hydrogen filling apparatus according to claim 1, wherein the control unit fills the second hydrogen tanks with hydrogen to make a difference in in-tank pressure between at least some of the second hydrogen tanks.

5. The hydrogen filling apparatus according to claim 1, comprising a fuel cell stack that generates electricity upon receiving hydrogen supplied from the first hydrogen tanks, wherein the hydrogen filling apparatus is actuated by the electricity generated by the fuel cell stack.
